(19) United States
(12) Patent Application Publication
(10) Pub. No.: US 2012/0321122 A1
(43) Pub. Date: Dec. 20, 2012

(54) SPEAKER

(76) Inventor: Kiyoshi Yamagishi, Mie (JP)

(21) Appl. No.: 13/577,615

(22) PCT Filed: Jan. 31, 2011
(86) PCT No.: PCT/JP2011/000506

§ 371 Date: Aug. 7, 2012

(30) Foreign Application Priority Data
Feb. 8, 2010 (JP) 2010 025082

(51) Int. Cl. H04R 11/02

(52) U.S. Cl. 381/398

(57) ABSTRACT

A speaker includes a frame, a magnetic circuit secured to the frame, a voice coil, a damper, and a diaphragm. The voice coil is inserted in a magnetic gap of the magnetic circuit. The damper is secured to the voice coil and the frame and formed with a plurality of corrugations. The diaphragm is secured to the frame and the voice coil. One of the plurality of corrugations located on an inner circumferential side of the damper is provided with a plurality of apertures, and these apertures are covered by an elastic member.

### TECHNICAL FIELD

The present invention relates to a speaker used in various acoustic devices.

### BACKGROUND ART

FIG. 4 is a half cross-sectional view of a conventional speaker. This speaker has magnetic circuit 21, frame 25, voice coil 26, damper 27, diaphragm 28, and dust cap 29. Magnetic circuit 21 includes plate 22, magnet 23, and yoke 24.

When a large input is applied to this speaker and voice coil 26 oscillates with an amplitude of more than a certain level, voice coil 26 goes beyond an appropriate range of the magnetic flux of magnetic circuit 21. This changes the magnetic flux applied to voice coil 26 from magnetic circuit 21, generating distortion. For this reason, large distortion can readily occur in large-amplitude oscillations, which may cause an abnormal noise depending on the speaker.

To improve this problem of abnormal noise, a speaker controlling the amplitude of oscillation has been devised, which actively suppresses displacement of the damper when the amplitude increases (see, for example, Patent Literature 1).

However, reinforcing an outer circumferential part of the damper in order to reduce the amplitude of oscillation leads to an increase in mechanical resistance due to friction and the like of materials. This leads to an energy loss and reduces the reproduction level of low frequency sound.

A speaker having damper corrugations with the width and height thereof being reduced from the inner circumference to the outer circumference to lower the flexibility of the outer circumferential part so as to reduce the amplitude in large-amplitude oscillations has also been devised. However, the effect of controlling the amplitude of oscillation is small with this configuration.

### CITATION LIST

### Patent Literature

PTL 1: Unexamined Japanese Utility Model Publication No. H02-133097

### SUMMARY OF THE INVENTION

The present invention resides in a speaker capable of effectively controlling the amplitude of oscillation in large-amplitude oscillations and of excellent low frequency sound reproduction, thus being able to reproduce high quality sound. The speaker of the present invention includes a frame, a magnetic circuit secured to the frame, a voice coil, a damper, and a diaphragm. The diaphragm is secured to the frame and the voice coil. The voice coil is inserted in a magnetic gap of the magnetic circuit. The damper is secured to the voice coil and the frame and formed with a plurality of corrugations. One of the plurality of corrugations located on an inner circumferential side of the damper is provided with a plurality of apertures, and these apertures are covered by an elastic member.

With the configuration described above, the speaker of the present invention is capable of high quality sound reproduction from input signals with high fidelity, as the corrugation in the inner circumferential part of the damper with apertures has higher flexibility and displaces first in small-amplitude oscillations. Parts of the damper other than the inner circumferential part without the apertures and having lower flexibility displace primarily in large-amplitude oscillations. Thereby, the speaker can readily oscillate at small amplitude where the magnetic flux is sufficiently applied to the voice coil and reproduce excellent low frequency sound, while the damper reduces the amplitude of oscillation of the voice coil at large amplitude to reduce distortion or abnormal noise.

### BRIEF DESCRIPTION OF DRAWINGS

FIG. 1 is a half cross-sectional view of a speaker according to one embodiment of the present invention.

FIG. 2 is an enlarged plan view of essential parts of the damper of the speaker shown in FIG. 1.

FIG. 3 is a graph showing “force-displacement” curves of dampers of the speaker according to the embodiment of the present invention and the conventional speaker.

FIG. 4 is a half cross-sectional view of a conventional speaker.

### DESCRIPTION OF EMBODIMENTS

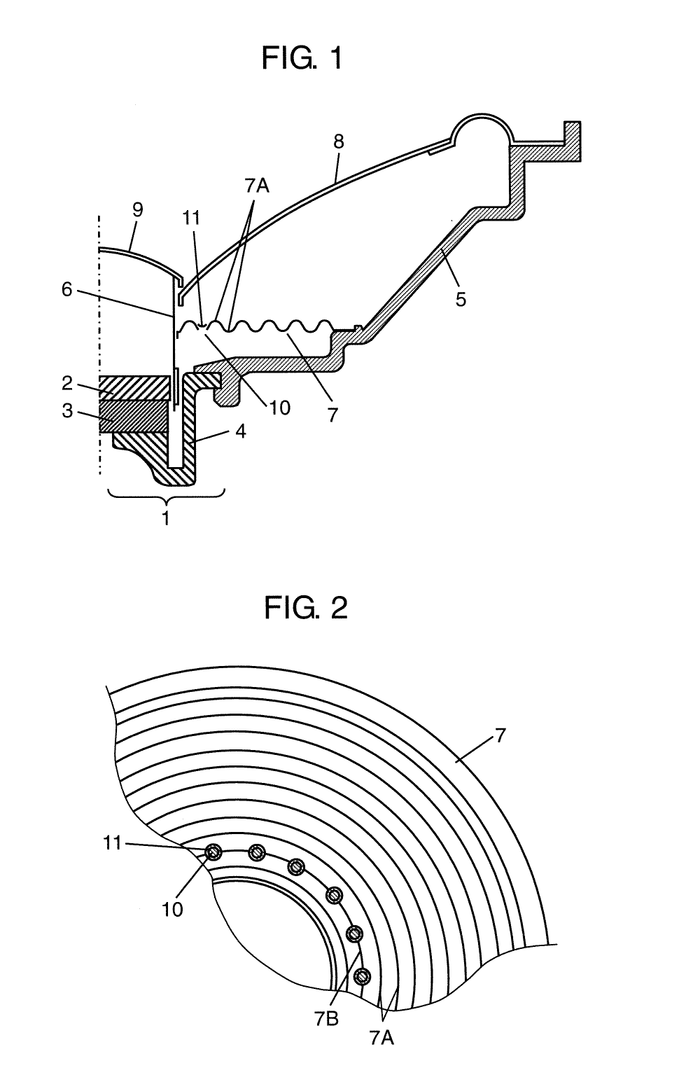

FIG. 1 is a half cross-sectional view of a speaker according to one embodiment of the present invention. FIG. 2 is an enlarged plan view of essential parts of the damper of this speaker. This speaker has frame 5, magnetic circuit 1, voice coil 6, damper 7, diaphragm 8, and dust cap 9. Magnetic circuit 1 includes magnet 3, plate 2 secured to an upper face of magnet 3, and yoke 4 secured to a lower face of magnet 3 and frame 5. A magnetic gap is formed between plate 2 and yoke 4. Magnetic circuit 1 is secured in an opening provided substantially in the center of frame 5.

Voice coil 6 is inserted in the magnetic gap of magnetic circuit 1. Damper 7 is secured to voice coil 6 and frame 5, and diaphragm 8 is secured to frame 5 and voice coil 6.

Damper 7 is formed with a plurality of corrugations 7A, 7B in a concentric manner. Corrugation 7B provided on an inner circumferential side of damper 7 is provided with a plurality of apertures 10, with elastic member 11 covering and closing apertures 10. Apertures 10 and elastic member 11 in one corrugation 7B are equally spaced so that the center of gravity of damper 7 is not eccentric. Dust cap 9 covers an upper opening of voice coil 6.

Damper 7 in this speaker is locally softer in the inner circumferential part provided with apertures 10 than other portions. Therefore, once oscillation starts, this part displaces first. Elastic member 11 covering apertures 10 provides a spring effect, which compensates for the restoring force of damper 7 reduced by provision of apertures 10 and prevents the damper from losing flexibility. Corrugation 7B provided with apertures 10 is located closer to the inner circumference than the middle between the outer and inner circumferences of damper 7.

Therefore, the speaker can readily oscillate at small amplitude where the magnetic flux is sufficiently applied to voice coil 6, and can reproduce excellent low frequency sound, and consequently the speaker can reproduce high quality sound from input signals with high fidelity.

As the amplitude increases and the displacement of the inner circumferential part reaches a certain level, portions without apertures 10 start to displace increasingly. Namely, these portions with low flexibility reduce the amplitude of oscillation of the speaker at large amplitude, so that the problems of distortion or abnormal noise caused by voice coil 6 going beyond the range of magnetic circuit 1 are improved.

Damper 7 provided with apertures 10 has higher flexibility as a whole than a damper without apertures. Therefore, to maintain the same level of Fo value of the speaker, a hard material needs to be adopted for damper 7. High-count (thicker) fibers, or a higher density resin for molding, may be used, for example.

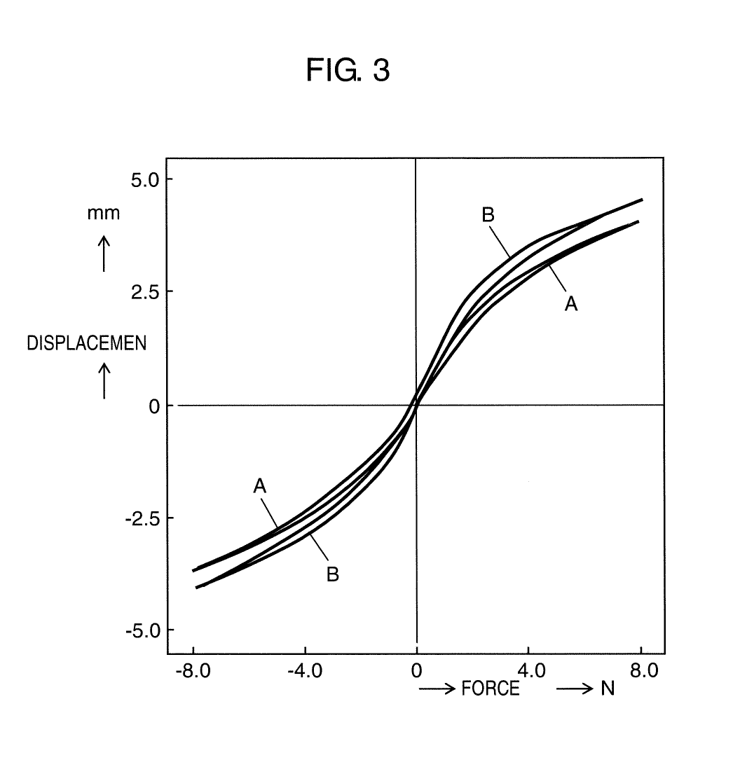

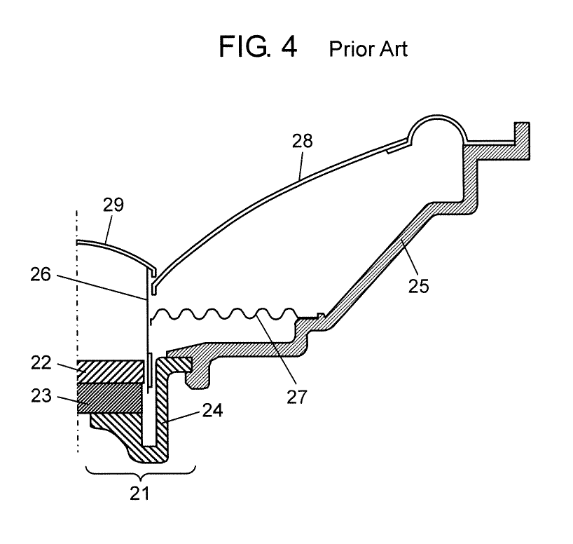

FIG. 3 shows “force-displacement” curves of dampers. The horizontal axis represents force and the vertical axis represents displacement. Curve A is a force-displacement curve of a conventional damper without apertures 10, and curve B is a force-displacement curve of the same damper provided with apertures 10 and elastic member 11 in an inner circumferential part. As is clear from FIG. 3, curve B has a higher slope factor than curve A in a small displacement range of 1 mm to 2 mm. Namely, it can be seen that the damper represented by curve B displaces with a smaller force. Thus it can be seen that this damper has higher flexibility.

Moreover, curves A and B become closer to parallel after the displacement exceeds 2.5 mm, which indicates that both dampers have equal flexibility.

Therefore, by making the base material of the damper represented by curve B appropriately harder than the base material of the damper represented by curve A, a speaker having the same Fo value and capable of readily displacing at smaller amplitude and of controlling the amplitude of oscillation at larger amplitude can be realized.

Elastic member 11 can be formed by molding or coating using rubber or a polymer resin. However, applying too much elastic member 11 on the damper will reduce the sound pressure due to the weight of elastic member 11 or reduce the sound quality by the viscous resistance. Therefore, the amount of application should be minimal, i.e., the corrugations should preferably be not covered continuously all around.

Damper 7 and voice coil 6 are secured to each other with an adhesive. It is preferable to provide apertures 10 and elastic member 11 to an innermost corrugation in an area not interfering with this adhesive. Namely, it is preferable to form elastic member 11 on a corrugation as close as possible to the inner circumference so as not to touch the adhesive. This configuration makes the change in the flexibility of damper 7 occur earliest after the speaker starts to oscillate. Thus the speaker can readily oscillate at small amplitude and reproduce even superior low frequency sound, and can reproduce high quality sound from input signals with high fidelity. This configuration is suited for full-range speakers and the like in which voice coil 6 can easily go beyond the range of magnetic circuit 1 because of the magnetic pole width and the coil width of voice coil 6 being close.

Elastic member 11 should preferably be made of a silicone resin. Reliability such as heat resistance can thereby be improved. Inner circumferential corrugations of damper 7 are close to voice coil 6 which is a heat generating element. Therefore, by arranging elastic member 11 made of a silicone resin having heat resistance and stable flexibility characteristics in relation to temperature in a portion close to voice coil 6, improvements in reliability as well as in the Fo value and the thermal stability of sound pressure frequency characteristics can be achieved.

Typically, a two-part acrylic adhesive or the like is often used for the bonding of damper 7 and voice coil 6 in consideration of strength and productivity. This acrylic adhesive has poor compatibility with silicone resins. Therefore, if elastic member 11 is made of a silicone resin, the acrylic adhesive applied on elastic member 11 will readily come off. There is such a possibility that a product quality issue may arise depending on the combination of the adhesive joining damper 7 and voice coil 6 and the resin forming elastic member 11. Accordingly, elastic member 11 should preferably be formed on a corrugation as close as possible to the inner circumference so as not to touch the adhesive.

While corrugation 7B provided with apertures 10 and elastic member 11 is concave in FIG. 1 as viewed in top plan view, it may either be convex or concave. While apertures 10 are provided in only one corrugation 7B in FIG. 2, apertures 10 and elastic member 11 may be provided in a plurality of corrugations.

### INDUSTRIAL APPLICABILITY

The speaker according to the present invention can be used in applications where the problem of distortion and abnormal noise in large-amplitude oscillations needs to be improved without compromising low frequency sound performance, and therefore this speaker can be favorably used in various acoustic devices.

### REFERENCE MARKS IN THE DRAWINGS

1 magnetic circuit

2 plate

3 magnet

4 yoke

5 frame

6 voice coil

7 damper

8 diaphragm

9 dust cap

10 aperture

11 elastic member

1. A speaker comprising:
a frame;
a magnetic circuit secured to the frame;
a voice coil inserted in a magnetic gap of the magnetic circuit;
a damper secured to the voice coil and the frame and formed with a plurality of corrugations; and
a diaphragm secured to the frame and the voice coil, wherein
one of the plurality of corrugations located on an inner circumferential side of the damper is provided with a plurality of apertures, the plurality of apertures being covered by an elastic member.

2. The speaker according to claim 1, wherein:
the damper and the voice coil are secured to each other with an adhesive, and
the plurality of apertures and the elastic member are provided in an innermost one of the plurality of corrugations in an area not interfering with the adhesive.

3. The speaker according to claim 1, wherein the elastic member is made of a silicone resin.

4. The speaker according to claim 1, wherein the elastic member is not continuously disposed on the at least one of the plurality of corrugations.
